(19) United States
(12) Patent Application Publication
(10) Pub. No.: US 2002/0139817 A1
(43) Pub. Date: Oct. 3, 2002

(54) Mobile dispensing apparatus

(76) Inventor: Wyman Travis, Curiew, IA (US)

Correspondence Address: DAVIS, BROWN, KOEHN, SHORS & ROBERTS, P.C., THE FINANCIAL CENTER, 666 WALNUT STREET, SUITE 2500, DES MOINES, IA, 50309-3993, US

(21) Appl. No.: 10/047,931

(22) Filed: Jan. 15, 2002

Related U.S. Application Data
(60) Provisional application No. 60/262,044, filed on Jan. 17, 2001.

(51) Int. Cl. G01F 11/20

(52) U.S. Cl. 222/413; 222/608; 222/626

(57) ABSTRACT

A mobile dispensing apparatus for dispensing flowable material from a plurality of containers is provided. The apparatus comprises a frame having an upper and lower portion connected with a plurality of supports. A wheeled axle connects to the lower portion of the frame to allow for moving the mobile dispensing apparatus. A plurality of container support frames contained within the upper portion of the frame provide support for containers. The apparatus includes a plurality of tapered bins with an open end connected to the upper portion of the frame for receiving the contents of the containers, and a closed end opposite to the open end located adjacent to the lower portion of the frame. A motor is attached to the frame, and an auger powered by the motor moves the contents of the containers from the closed end of the bins through the auger and out of the mobile dispensing apparatus.

### BACKGROUND OF THE INVENTION

The present invention relates to a mobile dispensing apparatus. In particular, to a mobile dispensing apparatus with an upper and lower frame that includes a plurality of tapered bins and an auger for dispensing the contents of containers affixed to the upper portion of the frame.

Many manufacturers and suppliers of grain seeds, fertilizers, and similar products, provide the products in large bulk box or bag containers. Use of these containers provides a convenient method to deliver the large quantities of these products needed by farmers and other large-scale users of these products. The size and weight of the containers, however, creates the need to use specialized equipment to transport the containers and to dispense the contents of the containers.

In the past a number of approaches have been tried. These include utilizing conventional farm vehicles like utility trailers, pickup trucks, and grain carts. None of these vehicles is particularly well suited to handle the weight and special shape and size of the containers. Recently, more specialized apparatuses have appeared in the field. These generally include some type of a bin feed mechanism that the container dispenses into, and a power auger to facilitate movement of the container contents from the bin to a vehicle that will ultimately apply the contents to the field. These devices frequently can only handle one container at a time, or require first dispensing the contents of the container into the device, which will then transport and dispense the contents into the application vehicle. In addition these devices can become very large, bulky, and expensive, especially when the devices are equipped to dispense a multiple containers.

Thus, a need exists for an efficient and simple mobile dispensing apparatus.

### SUMMARY OF THE INVENTION

These and other objects of the present invention will become apparent to those skilled in the art upon reference to the following specification, drawings, and claims.

The present invention intends to overcome the difficulties encountered heretofore. To that end, a mobile dispensing apparatus for dispensing flowable material from a plurality of containers is provided. The apparatus comprises a frame having an upper and lower portion connected with a plurality of supports. A wheeled axle connects to the lower portion of the frame to allow for moving the mobile dispensing apparatus. A plurality of container support frames contained within the upper portion of the frame provide support for containers. The apparatus includes a plurality of tapered bins with an open end connected to the upper portion of the frame for receiving the contents of the containers, and a closed end opposite to the open end located adjacent to the lower portion of the frame. A motor is attached to the frame, and an auger powered by the motor moves the contents of the containers from the closed end of the bins through the auger and out of the mobile dispensing apparatus.

### BRIEF DESCRIPTION OF THE DRAWINGS

FIG. 1 is a side perspective view of a mobile dispensing apparatus.

FIG. 2 is a top perspective view of the frame of the mobile dispensing apparatus.

FIG. 3 is a top perspective view of the frame of the mobile dispensing apparatus.

FIG. 4 is a side view of the frame of the mobile dispensing apparatus.

FIG. 5 is a side view of the connection between the tapered bins and auger of the mobile dispensing apparatus.

FIG. 6 is a front view of the connection between the tapered bins and auger of the mobile dispensing apparatus.

FIG. 7 is view of the connection between the tapered bins and auger of the mobile dispensing apparatus from the opposite side shown in FIG. 5.

FIG. 8 is a side view of the mobile dispensing apparatus with containers mounted on the apparatus.

FIG. 9 shows several views of an alternative design of the tapered bins.

### DETAILED DESCRIPTION OF THE INVENTION

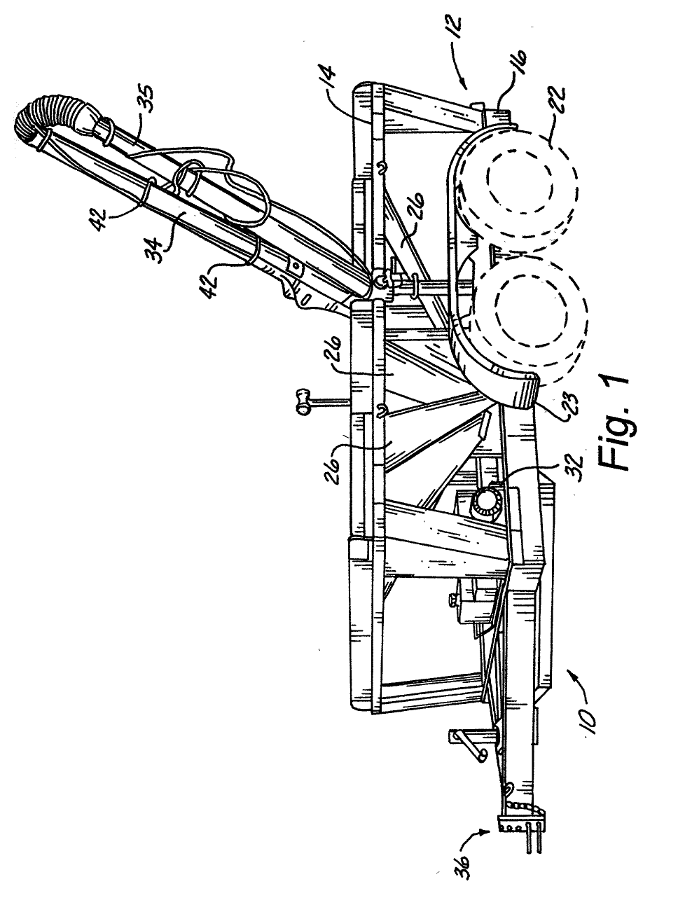

In the Figures, FIG. 1 shows a mobile dispensing apparatus 10 for the dispensing of a flowable material enclosed within containers. In the preferred embodiment of the invention, the flowable material comprises grain seed, namely, corn seed. The apparatus 10 includes a frame 12 consisting of an upper frame portion 14 and a lower frame portion 16, with supports therebetween. The frame 12 also includes axles 20 to which wheels 22 are attached to provide for movement of the apparatus 10. Additionally, the apparatus 10 includes a trailer hitch 36 to allow for attaching the apparatus 10 to a towing vehicle (not shown) to freely move the apparatus 10 as desired.

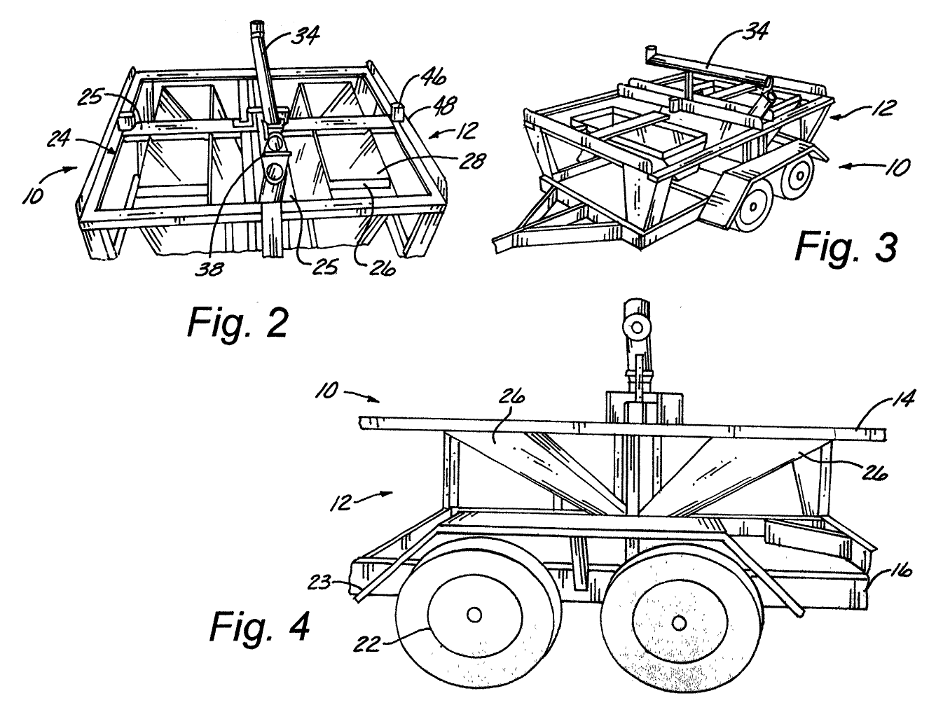

As shown best in FIGS. 2 and 3 the upper portion 14 of the frame 12 includes a plurality of crossing members 25 that divide the upper portion 14 of the frame 12 generally into a plurality of container support frame areas 24. Support post 46 along with support flanges 48 rigidly secured to the upper portion 14 of the frame 12 and to the crossing members 25 to form a partial perimeter to enclose the containers 44. One side of the container support frame areas 24 is left open to allow for conveniently inserting and removing the containers 44. In the preferred embodiment of the invention the apparatus 10 includes four container support frame areas 24.

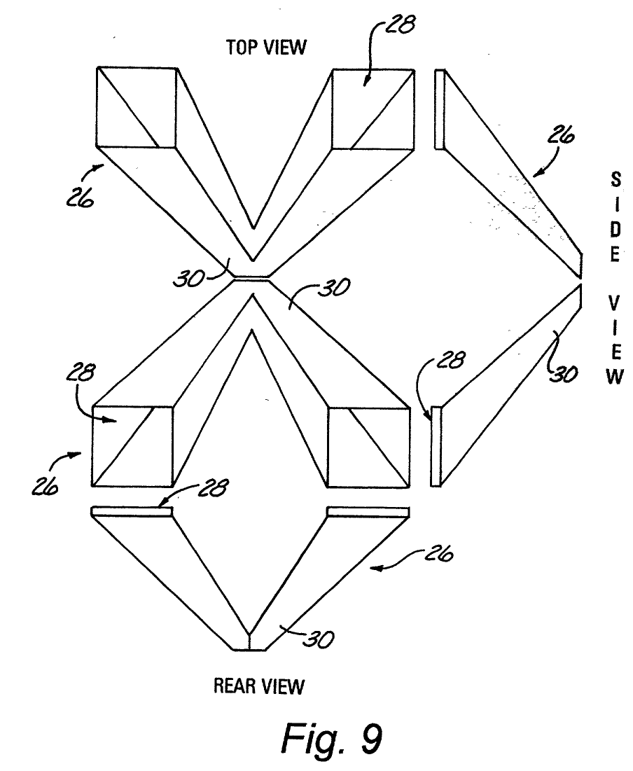

The apparatus 10 also includes a plurality of tapered bins 26. The bins 26 include an enlarged open end 28 secured to the container support frame areas 24, and a lower enclosed end 30 adjacent to the lower portion 16 of the frame 12. Enclosed end 30 of the tampered bins 26 join at the lower portion of an auger 34. In this manner, the flow able material can freely move from the containers 44 through the tapered bins 26 and into the auger 34. In the preferred embodiment of the invention, the apparatus 10 includes 2 tapered bins 26 that both terminate at closed ends 30 to feed into the auger 34. FIG. 9 shows several views of an alternative design of the tapered bins 26 that includes four open ends 28, wherein the closed ends 30 join together a common point to feed into the auger 34.

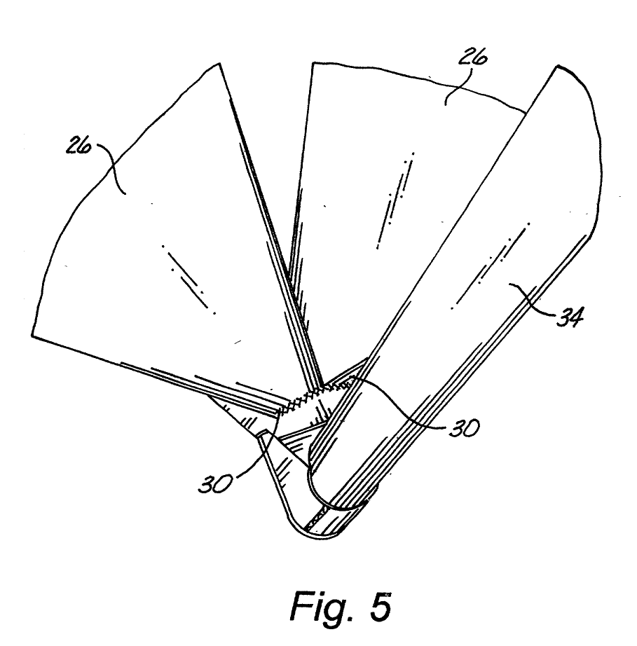

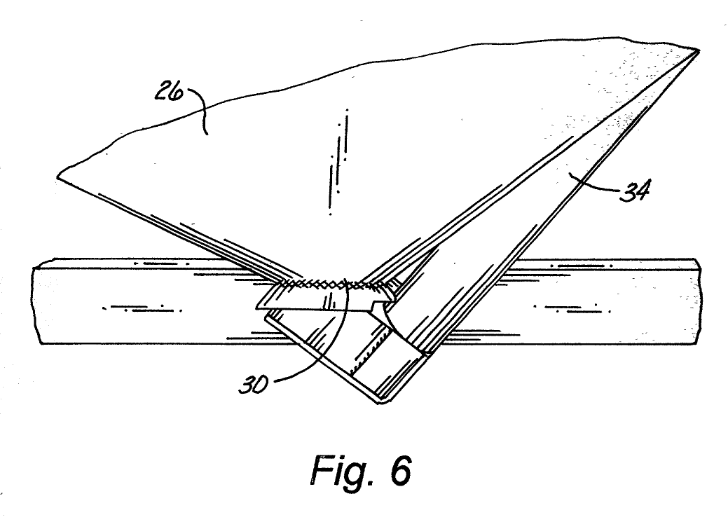

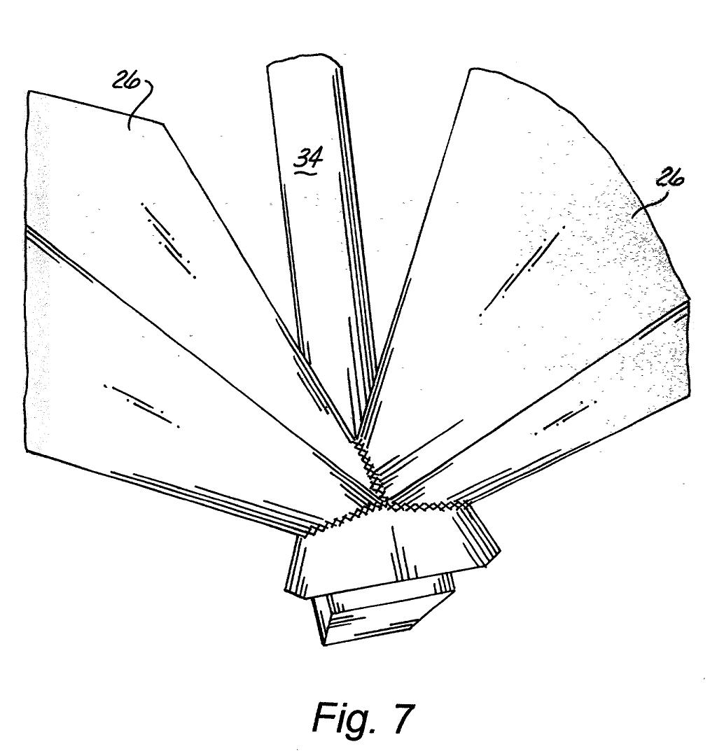

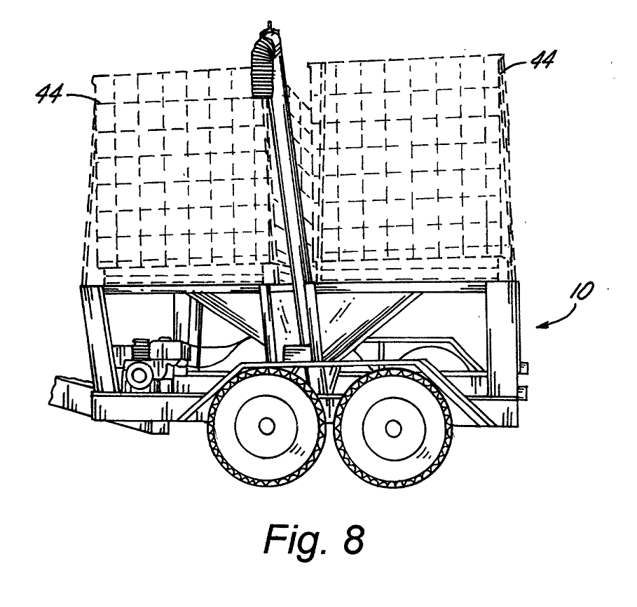

FIGS. 5, 6, and 7 show various perspective views of the point at which the enclosed end 30 of the tampered bins 26 meets the bottom of the Auger 34. The auger 34 is hydraulically powered by a motor 32, and includes a screw type auger shaft (not shown) enclosed within the auger 34 that provides a power means for transporting the flowable material out of the apparatus 110. The Auger shaft runs of the length of the upper right portion of the auger 34 thereby transporting the material into the downward pointing spout 35 which is adjustable to position it to dispense the flowable material as desired.

The auger 34 is telescoping to allow for adjusting its height as needed for appropriate dispensing. The auger 34 telescopes by collapsing or expanding the length of the auger 34 in three sections bounded by telescoping joints 42. Additionally, the auger 34 includes an auger hinge 38 to allow for moving the auger between an upright working position and a substantially vertical transport position. In particular, FIGS. 2 and 3 show the auger 34 in the storage position, wherein the auger 34 is supported on auger support 40 in the transport position.

The auger 34 consists of a commercially available five or six-inch poly cup auger produced and/or sold by Lundell Corp. of Odebolt, Iowa, and telescopes to a maximum length of fourteen feet. An 8-horse power Briggs & Stratton or Honda motor 32 is utilized power the auger 34.

In the preferred embodiment of the invention the containers 44 comprise 2500# containers. The overall length of the apparatus 10 is 100 inches wide and 176 inches in length. However, the apparatus 10 could be modified hold two containers. The two container version is 84 inches in width and 152 inches in length.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A mobile dispensing apparatus for dispensing flowable material from a plurality of containers, said apparatus comprising:
a frame having an upper and lower portion connected with a plurality of supports;
a wheeled axle connected to said lower portion of said frame to allow for moving said mobile dispensing apparatus;
a plurality of container support frames contained within said upper portion of said frame, for supporting the containers;
a plurality of tapered bins with an open end connected to said upper portion of said frame for receiving the contents of the containers, and a closed end opposite to said open end located adjacent to said lower portion of said frame;
a motor attached to said frame; and
an auger powered by said motor for moving the contents of the container from said closed end of said bins through said auger and out of said mobile dispensing apparatus.

2. The invention in accordance with claim 1 further comprising a trailer hitch for releaseable attaching said mobile dispensing apparatus to a towing vehicle.

3. The invention in accordance with claim 1 wherein said mobile dispensing apparatus comprises four container support frames for supporting four containers.

4. The invention in accordance with claim 3 wherein said mobile dispensing apparatus comprises two tapered bins wherein the open ends of each of said bins receives the contents of two of the four containers.

5. The invention in accordance with claim 3 wherein said mobile dispensing apparatus comprises four tapered bins wherein the open ends of each of said bins receives the contents of one of the four containers.

6. The invention in accordance with claim 1 wherein said auger is hinged and moves between an upright working position and a vertical storage position.

7. The invention in accordance with claim 6 wherein said auger between said upright working position and said vertical storage position under hydraulic power.

8. The invention in accordance with claim 1 wherein said auger is telescoping to adjust in height.

9. The invention in accordance with claim 1 wherein said mobile dispensing apparatus dispenses grain seed.

10. The invention in accordance with claim 9 wherein said grain seed is corn seed.

11. The invention in accordance with claim 9 wherein said grain seed is soybean seed.
